(19) United States
(12) Patent Application Publication
(10) Pub. No.: US 2003/0052091 A1
(43) Pub. Date: Mar. 20, 2003

(54) Blow-out system for a plug-in component

(76) Inventors: Dietmar Hillebrand, Bad Munder (DE); Daniel Horner, Neustadt (DE)

Correspondence Address: CANTOR COLBURN, LLP, 55 GRIFFIN ROAD SOUTH, BLOOMFIELD, CT, 06002

(21) Appl. No.: 10/184,696

(22) Filed: Jun. 28, 2002

(30) Foreign Application Priority Data
Jun. 29, 2001 (DE) 101 31 560.0

(51) Int. Cl. H01H 33/02

(52) U.S. Cl. 218/149

(57) ABSTRACT

The invention relates to a blow-out system for a plug-in component, for example an automatic cutout or a circuit breaker, and has a component housing (10, 20), at least one contact stud (40) arranged on a housing back, as well as at least one latching element (30), arranged on the housing back, for securing the component housing in the installed position. A bundle of laminations provided in the component for extinguishing an electric arc forming in the component has a blow-out channel (50), which is formed adjoining the bundle of laminations and leads to the outside of the housing, the blow-out channel (50) being partially limited by the latching element (30) on the housing outside.

The invention relates to a blow-out system for a plug-in or pluggable component and in particular the invention relates to the blow-out system of a circuit breaker or an automatic cutout that is designed as such a plug-in component.

Control centers or central stations of electrical installations are usually set up by combining individual components with one another on a top hat rail and then wired according to the purpose, specifications or function of the electrical installation. In this connection, different countries require compliance with different standards that are designed to ensure safety when working with electricity. In Germany, for example, components, as a rule self-contained, are standardized in such a way that in the installed position of the component the input side is on the bottom and the output side of the component is on the top.

The components are set up on an assembly rail, which because of its hat-shaped profile is called a top hat rail. Individual components are placed on the profile and secured there, the profile sections of the top hat rail, resembling the brim of a hat in profile, being partially encircled. A flexible latching section on the housing of the respective component is capable of being elastically deflected from the profile section upon insertion of the component and then grasps the profile section from behind. Subsequent wiring on screw terminals of the component then takes place.

Component systems already exist wherein a connection contact of a component is designed as a plug-in contact in order to save wiring of a screw contact. The plug-in contact is a contact stud projecting from the back of the housing of the respective component. The housing is additionally provided, on the housing side assigned to the contact stud, with the aforementioned flexible or latching mechanism for latching the component and the plug-in contact.

With regard to standards applied in different countries, which specify the different installed positions of components and/or assignment of the plug-in contact to an input or output side of the component and consequently define the location for the contact stud, it is desirable to have a component configuration which allows the different specifications of the respective countries for position and connection of the plug-in contact to be met without having to use another specially designed housing. This reduces the multiplicity of parts and the associated costs, risks and possibilities of failure.

For adaptation to specifications, it is necessary, when the same housing is always to be used for the component, to provide a corresponding recess for the contact stud and the latching mechanism at both sides of the component housing, i.e., on the input side as well as on the output side of the housing. Then, one of the two recesses can be equipped with the contact stud according to the specifications of the country, while the other side can be equipped with a screw terminal.

Many of the aforementioned components are or have switch elements that are capable of controlling the electric current flowing through the component in response to a particular criterion. Such components are in particular automatic cutouts or circuit breakers, which are able to monitor and turn off a current.

For the switch to interrupt the current, movable contacts are provided in the component, which contacts are separated upon tripping in response to the aforementioned criterion. If the contacts are separated from one another while in circuit, an electric arc is produced between these contacts. In order to extinguish this arc quickly and completely, a bundle of laminations is usually provided in such switches for arc extinguishing.

Along with the arc, gases or plasma, which are produced by the high energy density of the arc, additionally form within the component. This results in a rapid pressure increase in the component housing, a pressure increase that is reduced by gases blowing out of the housing. For this purpose, a blow-out channel is arranged at the end of the extinguishing laminations, which channel is turned away from the contacts and leads to the back of the component. For safety reasons, assembly is standardized with regard to metal ion content and temperature of the gas to be blown out by breakdown potential. In order to meet these standards, the gas to be blown out is cooled; a gas channel having sufficient length is generally provided in the component housing for this purpose.

The object of the invention is to propose an improved blow-out system for a plug-in component that is adaptable to a variety of installation standards, where the blow-out system ensures proper composition and temperature of the blow-out gas.

This object is accomplished by for example a blow-out system for a plug-in component having a component housing, a contact stud arranged on the housing back, a latching element arranged on the housing back for securing the component housing in the installed position, a bundle of laminations provided in the component for extinguishing an electric arc forming in the component and a blow-out channel, which is formed adjoining the laminations and leads to the housing exterior, the blow-out channel on the housing exterior being partially limited by the latching element. The plug-in component may in particular be an automatic cutout or a circuit breaker.

According to an advantageous embodiment of the invention, the blow-out channel may be branched, a partial channel running through the latching element and another partial channel running between the outside wall of the housing and the latching element.

In an additional advantageous embodiment of the invention, the blow-out channel partially limited by the latching cement may open out to the back of the component.

Further, in an advantageous embodiment of the invention the blow-out channel partially limited by the latching element may run through a flexible element provided on the latching element.

In an additional advantageous embodiment of the invention, the blow-out channel partially limited by the latching element may open into an accommodating groove formed on the housing back for an assembly rail made of synthetic material.

In additional advantageous embodiments of the invention, the blow-out channel in the housing interior may be separated from the contact stud by a separating wall and/or have a labyrinth section that forces at least one turn of the gas stream.

In addition, in another advantageous embodiment of the invention the blow-out channel in the housing interior may have at least one sudden widening in order to reduce the flow velocity of the gas.

In the following, the structure of a circuit breaker to which the invention is applicable will be explained first. It should be noted that application of the invention to components that have a different internal structure and require or use a blow-out channel advantageously is alternatively possible.

A circuit breaker has arranged in its housing a contact pair, of which one contact is designed as a stationary or fixed contact and the other contact is designed as a contact movable relative thereto. The movable contact is connected with a drive system, which may be a locking cam, a spring-preloaded lever mechanism or some other drive system.

In addition, the circuit breaker is provided with a tripping mechanism, which upon the occurrence of a triggering criterion trips the drive system for separation of the contacts, whereupon the movable contact is separated from the fixed contact and the circuit through the circuit breaker is interrupted.

The tripping mechanism usually detects the occurrence of an overload and/or an excess current as possible tripping criteria. For detecting an overload the circuit breaker is provided with a bimetallic strip that is traversed by the current to be monitored and, upon overload, i.e., too high a current present for a fairly lengthy period of time, bends until it actuates, i.e., trips, the drive system for separation of the contacts. For excess current, i.e., a high current occurring briefly, a magnetic system that has an armature and a coil traversed by the current to be monitored is generally used as the tripping mechanism. If an appropriately high excess current occurs in the coil, the armature is displaced by the magnetic field generated against the force of a flexible element and trips the switch. The contacts then are separated by the drive mechanism.

Upon separation of the contacts an electric arc may appear between the separating contacts; in order to extinguish the arc completely, a bundle of laminations is provided in the circuit breaker. Arranged following the extinguishing laminations is a blow-out channel, from which gas may be carried off. Free metal ions present in this gas should be carried off or guided into a specific area of the component housing in order for example to prevent a metallic layer from being formed at an undesirable location in the component housing. In addition, the blow-out channel should be designed so that the emerging gas attains a given breakdown potential.

As a rule, the housing of the component has the shape of a flat square stone. In the installed position the square has a back, a front side opposite the latter, which usually is also the operational control side of the component, and has narrow ends at the top and at the bottom as well as lateral surfaces at the left and right, which generally have the greatest extension. The front side usually carries control and indicating elements. This control part is frequently designed as a lever that permits manual opening and closing of the contacts. Usually, the lever setting in conjunction with a marking on the lever serves as a means for indicating switching status. Screw terminals for electrical connection of the switch are as a rule likewise accessible from the front side. Since the front side forms the visible side in the installed position, suitable identification fields are provided there for identification of the switch.

Contacting, i.e., electrical connection, takes place in the vicinity of the edges of the back, which adjoin the narrow sides. The contact stud of the plug-in component projects from the back perpendicular to the back, while the principal plane of the contact stud is aligned parallel to the principal plane of the narrow sides. A latching element or slide bar of synthetic material, which surrounds the foot region of the contact stud, is placed upside down over the contact stud. The slide bar moves displaceable against the force of a flexible or catching element, which is provided in one piece on the slide bar itself or on the housing, parallel to the principal plane of the back in grooves on the component housing. An accommodating groove for accommodation of an assembly rail (top hat rail) of synthetic material is additionally formed in the back of the component housing. The accommodating groove and the slide bar are matched to one another in such a way that the assembly rail is accommodated in the accommodating groove and the slide bar prevents release of the assembly rail from the groove because the slide bar is in engagement with an edge of the assembly rail.

The invention will be explained below in detail by a preferred example, with reference to the drawing, wherein:

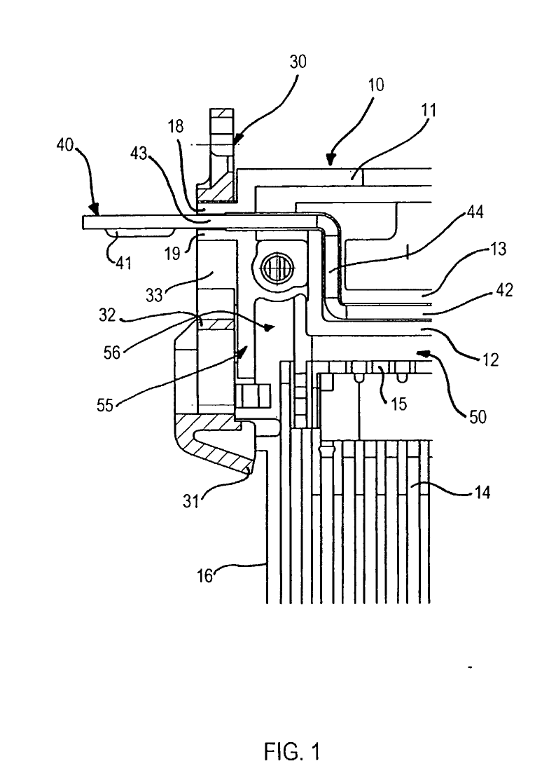

FIG. 1 shows a top view of an open housing corner of a plug-in component, where only one housing half is shown;

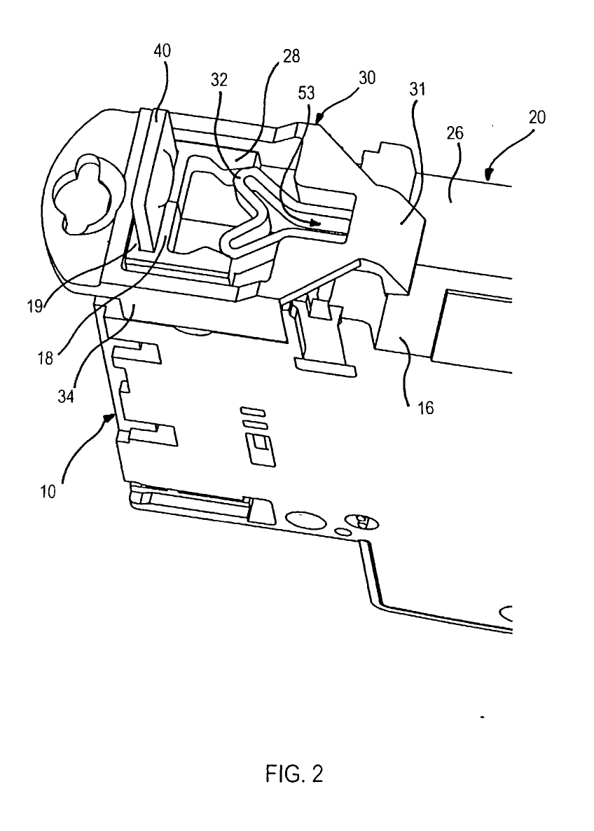

FIG. 2, a perspective exterior view of the housing corner in FIG. 1;

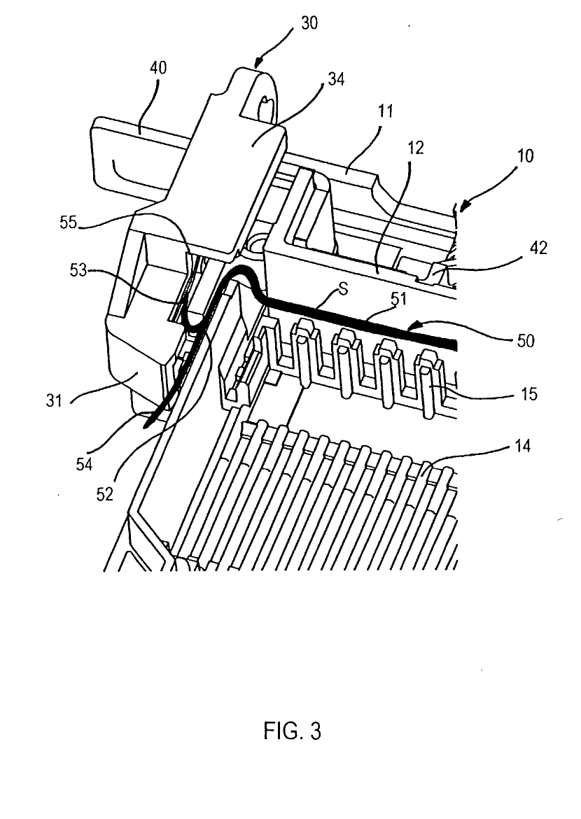

FIG. 3, a perspective view of the housing corner in FIG. 1;

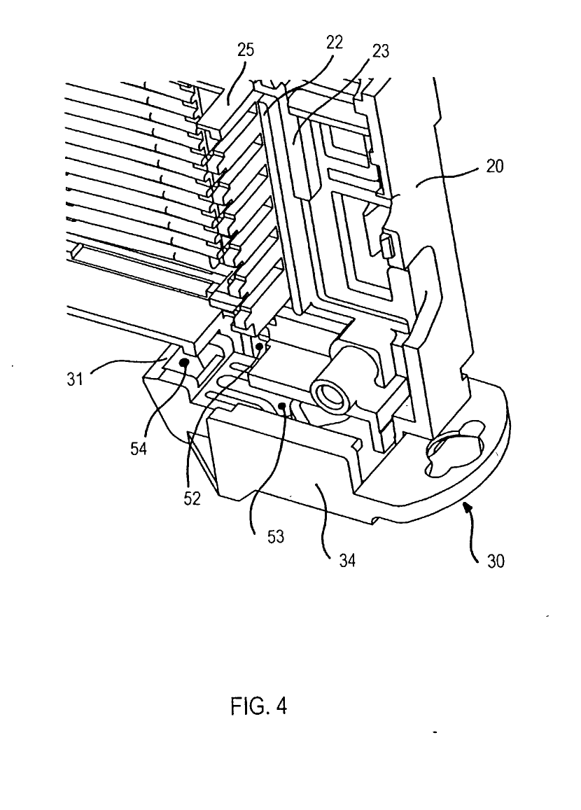

FIG. 4, the housing corner in FIG. 3 in a different perspective for clarification of the view into the slide bar; and

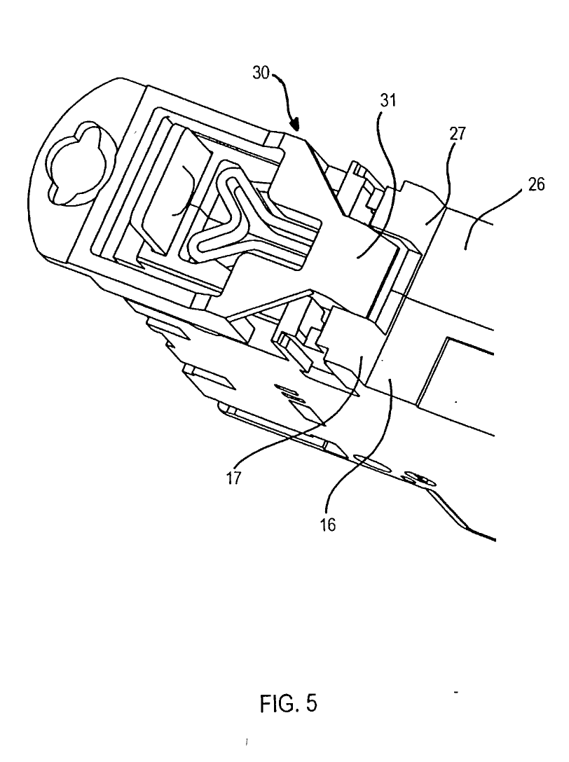

FIG. 5, a representation, corresponding to FIG. 2, of the housing corner with the slide bar in a release position.

FIG. 1, in a schematic representation, shows a top view of a portion of a housing half at one corner of the housing, in which a contact stud 40 of a plug-in component is accommodated. At the same time, this corner is that housing corner in which recesses 14 are provided for a bundle of extinguishing laminations (not represented). A lamination holder 15 is assigned to the end of the bundle that is turned away from the contacts to be separated (not shown). Connected to the holder 15 is a blow-out channel 50, which will be explained in detail later.

According to FIG. 1, the housing half shell 10 has an outer wall 11, which surrounds the housing shell. An accommodating groove 16 for an assembly rail is formed in the housing wall 11. Expressed differently, in the region of the groove 16 the housing wall 11 is set back in the direction of the housing interior. As may in addition be seen in FIG. 1, the contact stud 40 has an angled shape, in which sections 43, 44 and 42 successively each extend at right angles to one another. The section 43 of the contact stud extends through a housing passage 18, 19, which is formed as a continuation of the housing wall 11. A contact surface 41, which is formed by for example stamping of the contact stud 40, is provided at the outside end of the section 43 of the contact stud 40.

In addition, within the housing, guideways 12, 13 are formed with the housing half shell 10, in order to guide and hold the contact stud 40.

In FIG. 2, a portion of the housing corner is shown in a perspective view, said view corresponding to a view looking diagonally to the left in FIG. 1. In FIG. 2, the two housing halves 10 and 20 are shown in the assembled state. Here, it can be clearly seen that the accommodating groove 16, 26 is formed by the two housing halves 10, 20. A slide bar 30 surrounds the foot region of the contact stud 40, i.e., the guideways 18, 19 and the corresponding counterparts on the second housing half 20. The bar 30 has a central aperture, which is penetrated by the contact stud 40. A flexible Y-shaped element 32 is formed on the slide bar 30 and is in sliding engagement with guiding edges of the guideways 18 and 28 of the two housing halves 10, 20. The slide bar 30 in FIG. 2 is preloaded toward the right by the inclined guideways and the flexible element 32, so that a holding nose 31, which is formed on the slide bar, projects into the region of the accommodating groove 16, 26. In order to be displaceable, projections (not shown), which slide in grooves (not shown) that are formed on the respective housing halves 10, 20, are formed on the sides 34 of the slide bar 30. It should be noted that the slide bar 30 at the same time contributes to connection of the housing halves, in that the sections carried in the grooves and a one-piece design of the slide bar clamp the two housing halves together.

In FIG. 3, in a schematic perspective view of the housing corner of the open housing, i.e., of the housing half shell 10, the flow path of the blow-out channel is represented schematically by a heavy solid line S, where the line S is to be understood as a flow line running approximately centrally in the blow-out channel. A straight-line channel section 51, which runs curved around a section of the housing wall 11, in order then to be divided up in a labyrinth section 52 into two partial flows or partial paths 53 and 54, is represented in a collecting section behind the extinguishing lamination holder 15. One partial path 53 passes through an aperture in the housing wall and leads into the interior of the slide bar 30. The other partial path 54 avoids the slide bar 30 and opens in the region of the accommodating groove 16 to the outside of the housing. The partial path 53 leads into the interior of the flexible Y-shaped element 32, as is indicated by the reference numeral 53 in FIG. 2. The other partial path 54 leads under the holding nose 31 of the slide bar 30 and into the open. Division of the gas stream and the deflections in the housing reduce the velocity of the gas stream and the residence time of the gas stream in the housing is increased. As a result, more time is available for cooling of the gas stream by heat exchange with the housing wall upon blow-out and, in addition, a greater surface area is covered by the gas stream in a region of the component housing in which the precipitation or introduction of metal ions has no effect on the function of the switch. Thus, the legal requirements that determine the breakdown potential and for example the metal ion content of the blow-out gas can be met.

In an alternative embodiment, not shown, it is possible to form the partial path that leads under the holding nose of the slide bar as a path that leads into the interior of an assembly rail made of synthetic material. Then the interior of the assembly rail can act as a gas buffer, where the gas velocity can be slowed down, the gas cooled and the metal ions precipitated in the rail interior. The assembly rail may alternatively have slots for carrying off gas.

FIG. 4 likewise shows a portion of the second housing half shell 20 in a perspective representation. The extinguishing lamination holder 25 can be clearly seen in FIG. 4. On the right in FIG. 4, next to the extinguishing lamination holder 25, is shown a low separating wall 22, which when the two housing halves 20 and 10 (in FIG. 3) are joined comes into contact with the separating wall 12 at the face at the upper edge, in order to seal off the blow-out channel 50 in the direction of the contact stud 40. An elevation (23) formed in the second housing half shell 20 in FIG. 4 to the right of the low separating wall 22 acts as a support for the contact stud 40 (FIG. 3), in order to be able to grip and hold it laterally. In addition, points 52 to 54, which in each instance correspond to the corresponding partial-path points with the same reference numerals as in FIG. 3, are indicated in FIG. 4. This means that the flow path of the blow-out channel branches at approximately point 52 in order to emerge from the slide bar 30 at its upper side at point 53, while the other partial path crosses under the holding nose 31 of the slide bar 30 at 54.

Lastly, FIG. 5 again shows a detail view of a corner of an assembled housing with slide bar 30. In this position of the slide bar 30 shown in FIG. 5, the holding nose 31 is outside the accommodating groove 16, 26 for the assembly rail, limited laterally by the walls 17 and 27, so that the plug-in component can be released from and slipped onto the assembly rail. Then, if the slide bar 30 in FIG. 5 is pushed toward the right, the flexible Y-shaped element avoids the projections formed on the housing half shells and reaches the inclined surface turned toward the accommodating groove, owing to which the slide bar 30 in FIG. 5 is held preloaded toward the right, i.e., assumes a position as shown in FIG. 2.

1. Blow-out system for a plug-in component, in particular an automatic cutout or a circuit breaker, having
a component housing (10, 20),
at least one contact stud (40) arranged on a housing back,
at least one latching element (30) arranged on the housing back for securing the component housing in the installed position,
a bundle of laminations provided in the component for extinguishing an electric arc forming in the component, and
a blow-out channel (50), which is provided adjoining the laminations and leads to the housing exterior, the blow-out channel (50) on the housing exterior being partially limited by the latching element (30).

2. Blow-out system according to claim 1, characterized in that the blow-out channel (50) is branched (52), a partial channel (53) running through the latching element (30) and another partial channel (54) running between the outside wall of the housing (10, 20) and the latching element (30).

3. Blow-out system according to claim 1 or 2, characterized in that the blow-out channel (53, 54) partially limited by the latching element (30) opens out to the back of the component.

4. Blow-out system according to claim 1, 2 or, characterized in that the blow-out channel (53) partially limited by the latching element (30) runs through a flexible element (32) provided on the latching element (30).

5. Blow-out system [according to] one or more of the preceding claims, characterized in that the blow-out channel (54) partially limited by the latching element (30) opens into an accommodating groove (16, 26) formed in the housing back for an assembly rail made of synthetic material.

6. Blow-out system according to one or more of the preceding claims, characterized in that the blow-out channel (50, 51) in the housing interior is separated from the contact stud (40) by a separating wall (12, 22).

7. Blow-out system according to one or more of the preceding claims, characterized in that the blow-out channel (50) in the housing interior has a labyrinth section (55) that forces at least one turn of the gas stream.

8. Blow-out system according to one or more of the preceding claims, characterized in that the blow-out channel (50) in the housing interior has at least one sudden widening (56) in order to reduce the flow velocity of the gas.
